(19) United States
(12) Patent Application Publication
(10) Pub. No.: US 2019/0304006 A1
(43) Pub. Date: Oct. 3, 2019

(54) SYSTEM AND METHOD FOR WEB-BASED MAP GENERATION

(71) Applicant: Spot It Ltd., Guelph (CA)

(72) Inventors: Caleb OPERSKO, Guelph (CA); Andre BELISLE, Guelph (CA); Mohannad HUSSAIN, Guelph (CA); Ali ZEROUAL, Guelph (CA)

(21) Appl. No.: 16/367,488

(22) Filed: Mar. 28, 2019

Related U.S. Application Data
(60) Provisional application No. 62/649,180, filed on Mar. 28, 2018.

(51) Int. Cl. G06Q 30/06; G06F 9/54; G06F 16/29; G06F 16/21; G06F 16/23; G06F 16/9537

(52) U.S. Cl. CPC G06Q 30/0639; G06F 9/54; G06F 16/9537; G06F 16/219; G06F 16/2379; G06F 16/29

(57) ABSTRACT

Stores can create a virtual layout map either as a to-scale map or an approximate layout based off the existing presence. Data such as products, and their location are then given non-descript metadata such as aisle number or whatever is considered relevant to the property's owner. The system API can take in requests for product locations from multiple sources requesting with multiple distinct metadata points for a specific store location. The API will search the location's database via a central database for the location data based of the metadata and then return a map of the destination's location to the original source that requested the data. This system can also be used to create analytical maps based off historic data or via data imported from outside sources.

### CROSS-REFERENCE TO OTHER APPLICATIONS

This application claims priority from U.S. Provisional Application No. 62/649,180 filed Mar. 28, 2018 which is hereby incorporated by reference.

### FIELD OF THE DISCLOSURE

The disclosure relates generally to digital mapping and, more specifically, to a system and method of web-based map generation.

### BACKGROUND

Currently, consumers who are looking to make purchases have two options to obtain their product or products of interest. These options are either to purchase them in a retail store (physical realm) or to purchase them online (digital realm).

In practice, these two realms have very little interaction with each other even in the case where the retail store or the website are both operated, or owned, by the same entity. This places retail store or property owners, also seen as physical retailers, at a disadvantage, as they compete with competitors in other retail, or physical, stores along with online merchants. In general, online merchants do not have the same overhead compared with the physical retailer. In some cases, the retail store may only serve to be a pick up point for consumers who purchase a product online.

In order to assist physical retailers to enhance their sales, some retail stores now have their store, or property, digitally mapped to assist consumers when they are in the store. However, physical properties do not follow a universal shape and layout as the store building needs to adapt to the land and demographic conditions of the location. Often, mapping involves either a highly technical map for store use which is complicated for consumers to understand or a simplified customer map that needs to be centrally developed which often leaves them outdated or slow to adapt to changes in the retail store such as a shifting of department or products form one location to another. If a map needs to be changed to reflect any change to the actual location, map designers often need to spend large amounts of time going back and forth between the location and the map so that it can reflect the updated locations in the store.

In past practices, the goal was to have consumers spend as much time as possible at a retail store as this would result in increased revenue, however, digital, or online, competitors can offer a convenient, fast experience that still allows a consumer to see all the products available without having to walk around a retail store. This means that retail store owners have to offer a fast, convenient experience at their store or risk losing consumers to online merchants. With the multitude of online options available to consumers, consumer retention is more important than ever.

Some retail stores have tried to take the initiative in terms of improving consumer, or shopper, experiences both online and at the physical store. Some solutions include posting a generalized location such as an aisle if a product is in stock but at a physical location where there are over a hundred aisles, this can be just as confusing. Another current solution is a generalized layout map but this suffers from information being out of date or being too broad which lowers the potential convenience to a consumer.

Therefore, there is provided a method and system of web-based map generation that overcomes disadvantages of current systems and methods.

### SUMMARY OF THE DISCLOSURE

According to an aspect of the disclosure, there is provided a system for in-store digital mapping including an application programming interface (API) for receiving a mapping request from a requesting source; a first database for storing data relating to maps associated with physical locations; and a second database for storing historical data relating to maps associated with physical locations.

In another aspect, the API includes a central database module; a historical database module; a property owner's systems module; and a third-party systems module. In a further aspect, the third-party's system's module communicates with requesting sources outside a retailer's network. In yet another aspect, the property owner's systems module communicates with requesting sources within a retailer's network. In an aspect, the central database module communicates with the first database. In another aspect, the historical database module communicates with the second database.

In yet another aspect, the system further includes a map editor connected to the first database. In another aspect, the map editor is web-based.

In another aspect of the disclosure, there is provided a method of generating an in-store map including determining if a user has selected a storing element or a non-storing element; retrieving metadata associated with the storing element if a user has selected a storing element, sensing placement of selected storing or non-storing element in map; and storing placement of selected or non-storing element and metadata in a central database.

In another aspect, the method includes determining if a map has been updated; and storing changes or updates to the map in a historical database.

In a further aspect of the disclosure, there is provided a method of digital map generation including receiving a request for a map from a requesting source; determining a type of map requested; accessing a database to retrieve the type of map requested; generating the map based on the type of map requested; and transmitting the generated map to the requesting source.

In another aspect, determining the type of map requested includes determining if a store location map or an analytical map is requested. In a further aspect, if a store location map is requested, accessing the database to retrieve the type of map requested includes retrieving the store location map from a central database. In yet another aspect, if an analytical map is requested, accessing the database to retrieve the type of map requested includes retrieving the analytical map from a historical database. In yet another aspect, the method further includes determining a view of the store location map being requested. In an aspect, transmitting the generated map to the requesting source includes transmitting a map based on the determined view.

According to an aspect of the present disclosure, there is disclosed an interactive digital mapping system including a central API to manage requests for maps from sources and the generation of maps to those sources, a central database manager that manages all stored data and can direct requests to the necessary data, a series of locations specific databases for each location, a map editor by which a user can generate a map and store related data for a location and a historical database so that analytical maps can be generated from past data.

Another aspect of the present disclosure is a central application product interface including input ports to receive requests for maps, whether from internal systems or from third-party systems, a processor or method executing on a processor to determine if these requests are valid or whether they should be returned as invalid, a map generator to generate maps from stored data specific to a location, a processor or method executing on a processor to request this data from a central database that stores and manages all the location specific data for all locations within the system, a processor or method executing on a processor for importing outside data or using historical data and attaching that data to stored data in the system to generate analytical maps and a processor or method executing on a processor to request historical data that has been collected by the system to generate analytical maps. The processor may be the same in each example.

Another aspect of the present disclosure is a central database manager including a directory of databases specific to individual locations that have layouts and stored data inside, a processor or a method executing on a processor by which to search within each database to pull the necessary data that is being requested and a processor or method executing on a processor to determine if the data being requested is stored in any location.

Another aspect of the present disclosure is the local database which includes all stored elements (whether they be storing or non-storing elements) and any necessary metadata that pertains to the location of products or destinations at a given physical location.

Another aspect of the present disclosure is a map editor, preferably online, including an interface by which a user can make storing or non-storing elements and generate a visual representation of the physical location, a processor to add in metadata to these stored elements so that it can be searched by multiple sources and accessed by the central API as well as a method by which a user can view and manage a map and elements in different views or layouts as they would need to be requested.

Another aspect of the present disclosure is a historical database including past requests from sources and what those requests contained and the knowledge if the layout of any location has changed.

According to another aspect, there is provided a web-based mapping system including a central API that can generate maps based off stored data within the maps themselves. The system may also include a web-based map creation and management portal or editor including virtual elements to be managed to reflect the layout of physical locations and what may be stored there and/or the ability to store metadata inside elements within a map to generate maps based off requested destinations or products.

In another aspect, the central API can take in requests from connected or third-party systems for maps of highlighted areas to reflect products or destinations. In a further aspect, the API can discern whether a request for a map request is valid or not. In another aspect, should the requested metadata not be stored within a location, the API may search for associated metadata within a location to create a map based off a request even if the requested metadata is not available. In another aspect, a singular map can be generated or managed to show different layouts or views depending on the source requesting the map. In yet another aspect, the elements are the same for all prospective layouts or views, but the data stored inside determines which elements and which data stored within them is shown in any prospective views or layouts.

In another aspect, areas of a map or groups of elements may be grouped together to create interactive zones which, when interacted with, show the map in more detail. In another aspect, information from historical data can be received and overlaid onto a map to provide analytical insight about a location. In yet a further aspect, information can be imported from an outside source and the analyzed and overlaid onto a map of a location to give analytical insight about a location.

In another aspect, all requests or maps generated through the central API are recorded so that analytical data can be extracted from the system. In a further aspect, any changes to the layout of a map are recorded so that it can be presented when a user seeks out historical data. In an alternative aspect, different networks or brands of locations can be made or grouped together within the central system to be accessed by related systems.

In yet another aspect of the disclosure, there is provided a system by which outside imported data is brought in bulk unsorted data. The system may then search for metadata that is stored in a network's maps or metadata that can be associated to metadata stored in maps within a network and then sort the bulk data to reflect imported data in terms of metadata stored in a network of maps.

In another aspect, data can be put into predetermined or requested ranges and then generate maps to reflect multiple or all elements in a map in relation to that data and the stored metadata within these ranges.

In yet a further aspect of the disclosure, there is provided a system by which all elements from all locations within all connected networks are centrally stored for access from the central API whereby each physical location has their own sub-database. In another aspect, the system may further include one sign-in or authentication process to access the map generation or management portal or editor for all locations and all networks with users signing-in via a web based portal.

### BRIEF DESCRIPTION OF DRAWINGS

Embodiments of the present disclosure will now be described, by way of example only, with reference to the attached Figures.

FIG. 1 is a schematic diagram of one embodiment a digital mapping system according to an embodiment of the present disclosure;

FIG. 2 is schematic diagram of an application programming interface (API);

FIG. 3 is a flowchart for creating a network within the system;

FIG. 4 is a flowchart for creating an account in the network of FIG. 3;

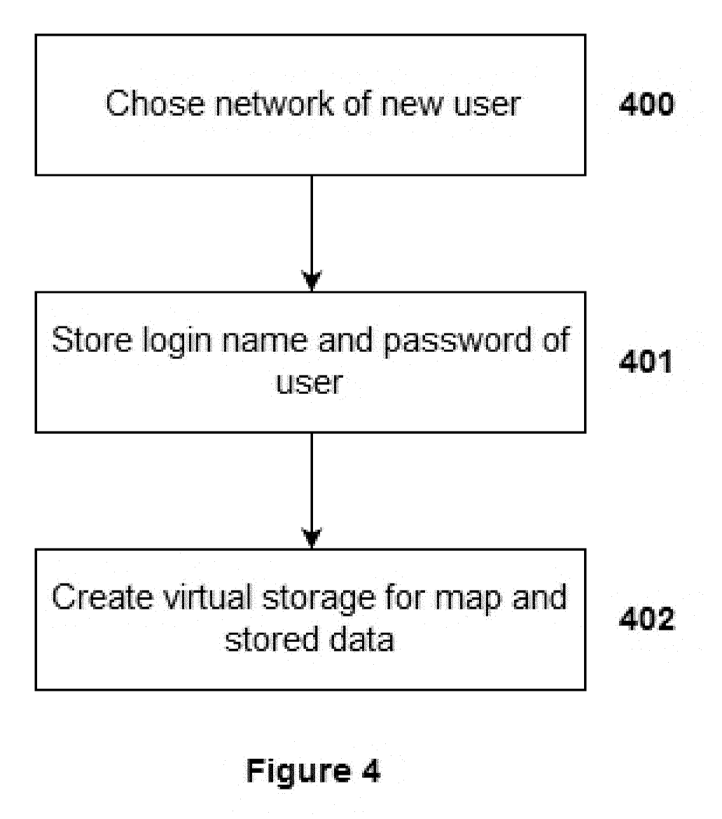

FIG. 5 is a schematic diagram of a map editor for use in generating or updating a map;

FIG. 6 is schematic diagram of non-storing elements for use by the map editor;

FIG. 7 is a schematic diagram of storing elements for use by the map editor;

FIG. 8 is a flowchart of the creation of an element for use in a map;

FIG. 9 is a schematic diagram of a storing element in different views according;

FIG. 10 is a schematic diagram of a layered view of an element in different views;

FIG. 11 is a schematic diagram of how elements are all stored in the same database location;

FIG. 12 is a flowchart of a method of loading an account;

FIG. 13 is a flowchart outlining a method of updating a map;

FIG. 14 is a schematic diagram of a map request;

FIG. 15 is a schematic diagram of an analytical map request;

FIG. 16 is a flowchart of a method of displaying a digital map;

FIG. 17 is a schematic diagram of a standard map generated by the system;

FIG. 18 is a flowchart outlining a method of displaying an analytical map;

FIG. 19 is a schematic diagram of a standard analytical map; and

FIG. 20 is a schematic diagram of map linking.

### DETAILED DESCRIPTION

The disclosure is directed at a method and system for digitally mapping a physical location. In one embodiment, the physical location is a retail store. The disclosure provides a system that facilitates the generation of a map and to perform updates to these maps as changes are made to the layout of the physical location. In another embodiment, a request is received by the system (from a requesting source) for either a digital map of a physical location or an analytical map of the physical location which may provide information associated with changes that have been previously made to the map of the physical location. The system retrieves the requested information and then transmits this information to the requesting source.

For ease of understanding, in the following description, any reference to a “property location”, “location” or “store” represents any large scale physical property that has a need to aid consumers, shoppers or visitors to find their destination within the physical property. In one embodiment, the destination may be the location of an item of interest for purchase within the physical property. These terms are used interchangeably within the specification and will mean the same even though they could vary greatly in terms of actual physical presence. Also, the terms “retail property owner”, “retailer”, “manager” or “property owner” represent the owner of the physical location that is being or has been digitally mapped. These terms may be used interchangeably within the specification and will mean the same within the specification even though they may differ in industry.

Also, the terms “destination” or “product” represent what an end user would be looking for in the physical location. These terms may be used interchangeably within the specification. Also, the terms “visitor”, “shopper” or “customer” represent a person who is visiting the physical location and will be aided using a map generated by the system and method of the disclosure.

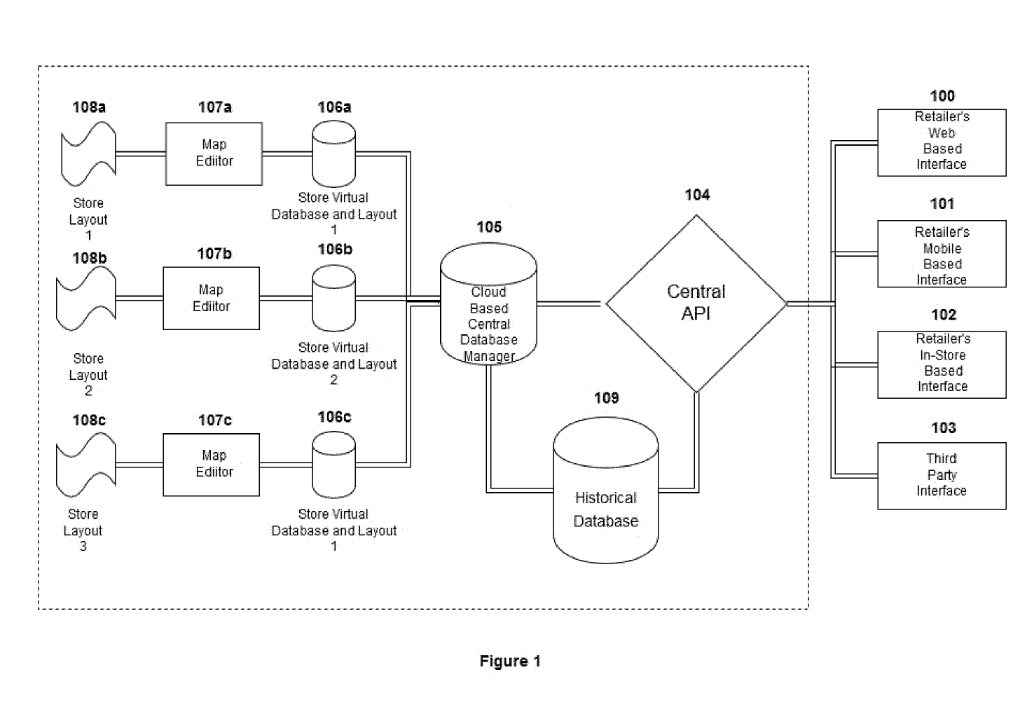

Turning to FIG. 1, a schematic diagram of a system for digitally mapping a physical location is shown. In the current embodiment, the system 10, which may be associated with a retailer, is connected to, and communicates with, a plurality of different requesting sources 100, 101, 102 and 103 to transmit and receive information. These requesting sources 100 to 103 may be from internal sources associated with the retailer or from external, or third party systems. In the current embodiment, requesting source 100 is a retailer's web-based interface, requesting source 101 is a retailer's mobile-based interface, requesting source 102 is a retailer's in-store based interface and requesting source 103 is a third-party interface. These requesting sources or interfaces may be consumer facing or used in the background to request analytical maps or both.

The requesting sources 100 to 103 interact with the system 10 via a central application programming interface (API) 104 which receives requests from the sources 100 to 103 and then retrieves the requested information from the system 10 and then transmits it to the requesting source. The API 104 may also direct requests for the stored information from a, preferably cloud-based, central database manager 105. The central database manager 105 is in communication with connected databases 106a to 106c and stores the data or URL addresses for these databases 106a to 106c in a central location so that it can easily accessed by the API 104. Each database 106 represents information associated with a physical location, such as the most current map of the physical location.

Each database 106 is preferably connected to an associated map editor 107 and is assigned a store layout 108. In the current embodiment, each database 106, map editor 107 and store layout 108 grouping represents a different type of layout view that can be generated by the system 10. These layout views will be described in more detail below. As will be understood, the number of groupings may change as different views are created. Alternatively, the groupings may be seen as groupings for different physical locations that may belong to the same retailer or retail owner.

The individual databases 106 store any data that is generated, added, or updated, by a user, via the associated map editor 107. In a preferred embodiment, the map editor 107 is preferably a web-based interface that is used to create or manage a map representing the store layout 108. The system 10 may also include a historical database 109 that interacts with the API 104 and the central database 105 to keep track of requests or changes to individual maps so that analytical maps of a physical location may be created or updated. In other words, the historical database may store older maps such that comparisons between current maps and previous maps may be performed, when required or requested. The historical database may also store a list of changes or updates made to previous versions of the map or maps.

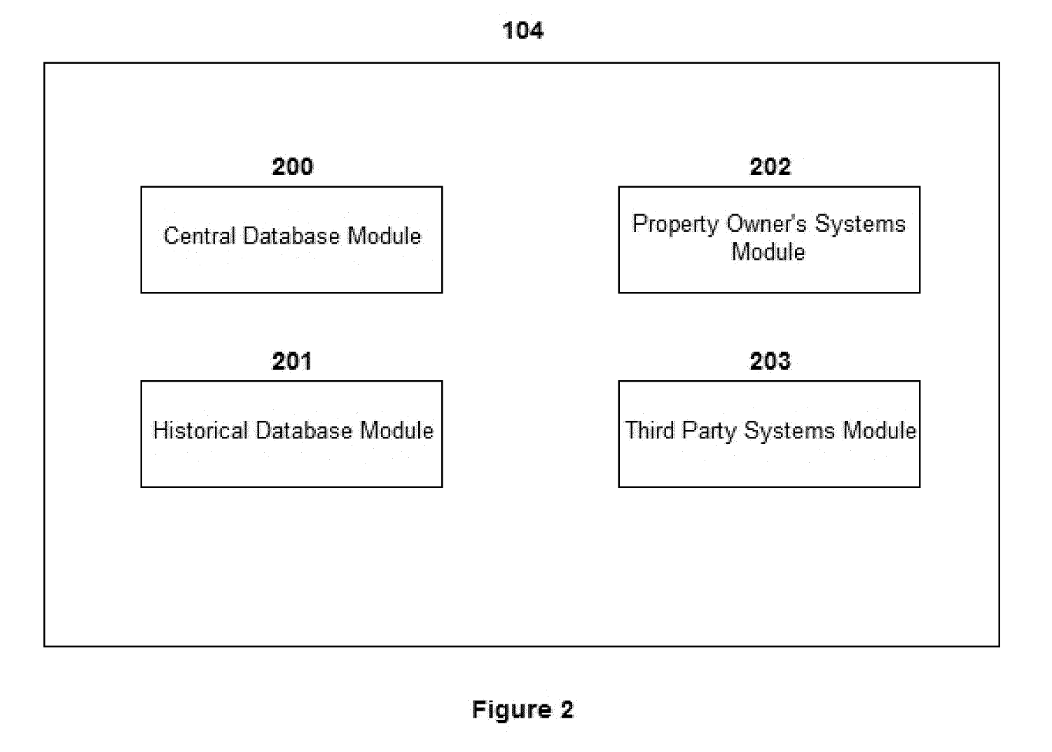

In a preferred embodiment, the central API 104 (schematically shown in FIG. 2) coordinates the functioning of all associated components of the system. The API 104 receives requests (such as from the requesting sources 100 to 103) and then retrieves the requested information (such as maps) and transmits this information to the requesting source.

In the current embodiment, the API 104 includes a central database module 200, a historical database module 201, a retail property owner's system module 202, and a third party systems module 203.

In operation, the API 104 operates and communicates both internally (with components or requesting sources within the retailer's system) and externally (with components or requesting sources outside the retailer's system) to transmit and receive data. Internal data transmission and communication by the API 104 is via the central database module 200, the historical database module 201 and the retailer property owner's system module 202 while external data transmission and communication by the API 104 is via the third-party systems module 203. Communication between the API and these components may include, but is not limited to, maps and any problems with requests and the requests themselves. Although multiple modules are shown, it will be understood that some or all of the modules may be implemented in a single module.

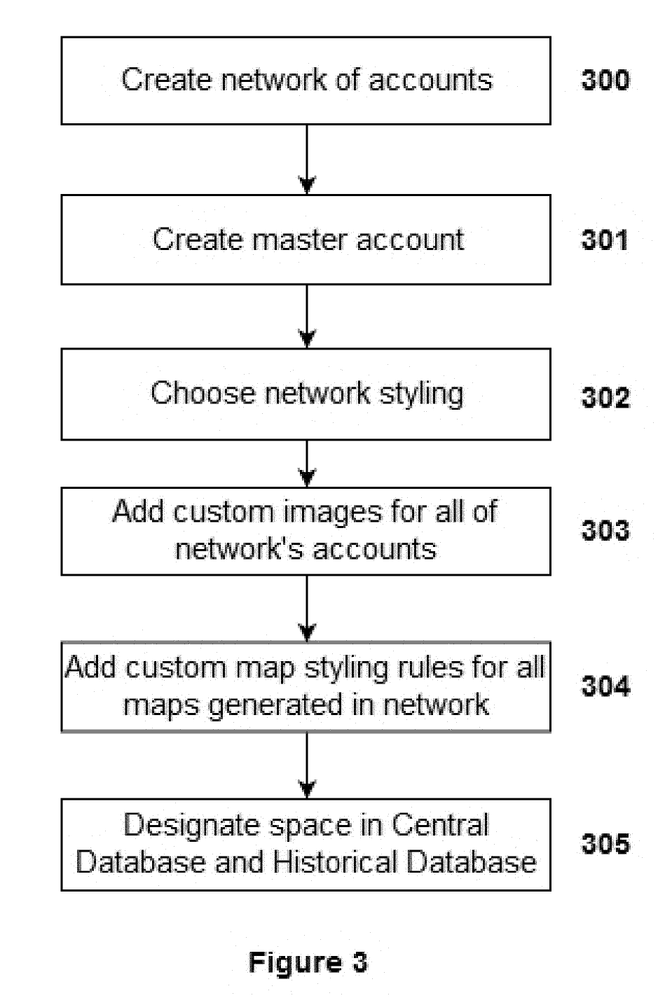

Turning to FIG. 3, a flowchart outlining a method of setting up a network for use with the system for digital mapping is shown. In one embodiment, the network is used to identify different brands, or retailers, that may be using the system for digital mapping or to identify a physical location. For instance, components 106a, 107a and 108a may be one brand; components 106b, 107b and 108b may be a second brand and components 106c, 107c and 108c may be a third brand. Alternatively, components 106a, 107a and 108a may be one retailer; components 106b, 107b and 108b may be a second retailer and components 106c, 107c and 108c may be a third retailer.

Initially, a network of accounts is generated (300) such as by a system administrator. The network of accounts is preferably associated with the brand and serves as an identification of the network. The network of accounts may also be associated with a retailer or a specific physical location. A master account, such as for a central administrator, is then created or generated (301) and is associated with the network of accounts. After the master account has been set up, the styling for the brand is set up (302). This set up may include images, elements and/or parameters for the map design (303). For example, assigning colours for the maps as well as custom images for the maps, such as, but not limited to, logos to be included in maps or anything else that may be required. Other styling, such as, but not limited to, rules for maps generated such as “display map as a three-dimensional (3D) map” or analytical rules may also be set (304). Storage space, such as within the central database and/or the historical database can then be designated for the network of accounts (305).

Once a network has been setup, individual accounts for the network can be set up. In one embodiment, each individual account may relate to a different individual associated with the physical location of a store or brand. Initially, the account is associated with the brand (or brand network) (400) as created in FIG. 3. The individual account can then be assigned or designated a username and password (401), which could be the same or associated with any technology systems that the retail owner has in place to reduce or prevent additional sign-ins. With the creation of the username and password, the system designates space in the databases as well as creates a virtual database specific to that location 402. In the current embodiment, brands may be different companies.

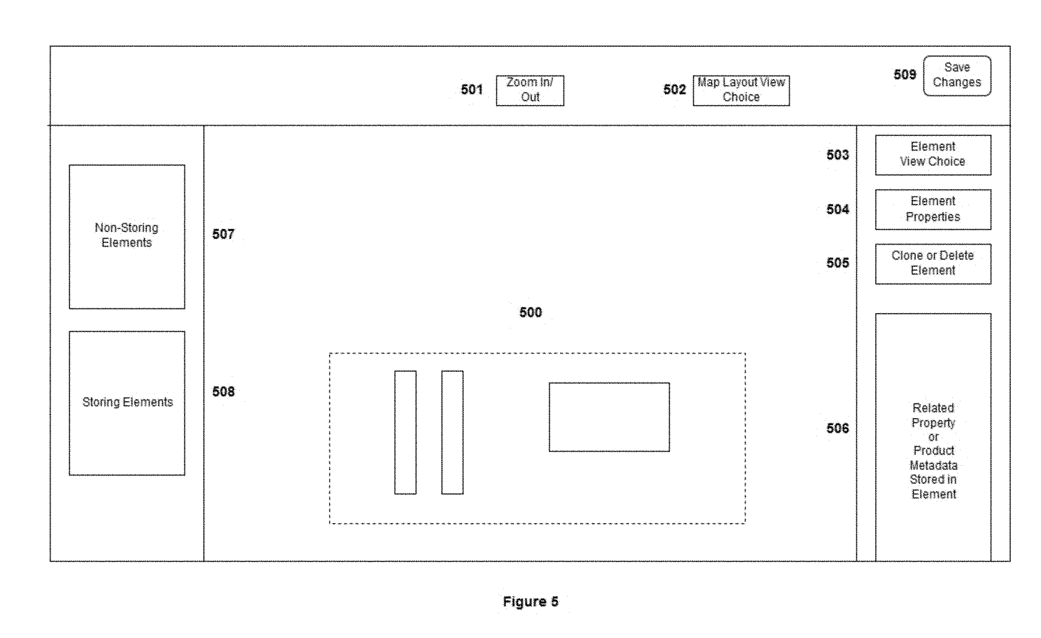

With the network and account set up, a user can then start to generate and edit maps by signing into the system to use web-based map editor 107 associated with that location or layout. The interface is preferably universal across all networks but may include adjustments for specific networks such as images or element colours. An example screen shot of a map editor is schematically shown in FIG. 5. A map generally includes storing elements and non-storing elements.

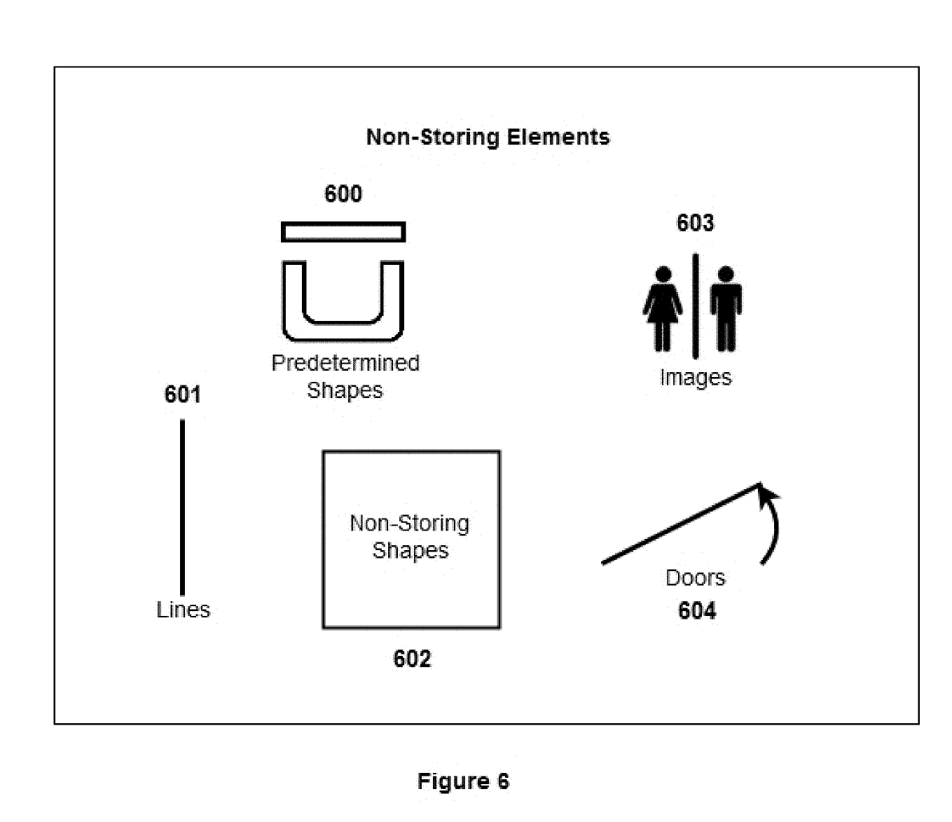

Turning to FIG. 6, examples of non-storing elements are shown. Non-storing elements are elements, or components, in a map that do not store metadata that can be related to desired locations. Examples include, but are not limited to, desks 600, lines that can designate walls or boundaries 601, non-storing shapes which can be used for various reasons 602, images such as logos or icons for bathrooms 603 and doors to show entrances or exits 604.

Storing elements are elements or components in the map that store metadata and are highlighted to help guide consumers or visitors to their end destination. Storing elements vary in their appearance from non-storing elements and have extra aspects in the map editor that allow users to add associated information to assist the API generate the requested maps. Storing elements differ in that they hold the metadata that is required to generate a map for the requesting source. The data stored can be anything of value for the property owner that may need to be requested such as layout terms, aisle numbers or merchandising data. Storing elements hold, or store, data that is required to generate maps while the non-storing elements are images.

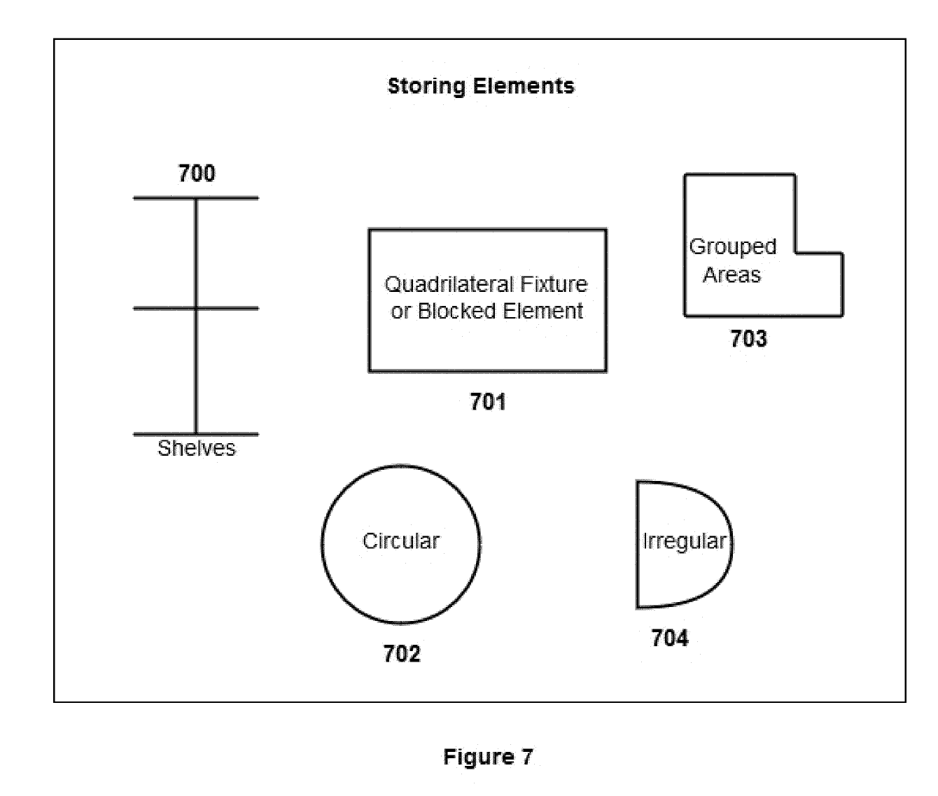

As shown in FIG. 7, storing elements include, but are not limited to, one or two-sided shelves for stores 700, quadrilateral or blocked elements which can designate grouped areas or areas such as a bin in a store 701 but can also have predetermined shapes such as desks but ones that need to store data so that they can be highlighted. Storing elements may further include circular shapes to define circular storage areas in stores 702 or irregular shapes 704 that represent odd shaped fixtures in a location or predetermined shapes like desks. Another storing element may be a grouped area of a map which may include multiple elements in a single grouping whereby when the grouping is selected, a more detailed view or the area can be shown 703.

In the example schematic diagram of FIG. 5, the map that is being edited or generated 500 is in a centre of the screen with editing tools surrounding the map. In the example of FIG. 5, the map editor includes a zoom functionality 501 and a map layout view choice functionality 502 that allows a user to see the map in various views. Further functionality may include, but is not limited to, functionality that allows a user to edit or manage aspects of the metadata or element/component in the map. In the current embodiment, the user may view a specific element (or component of the map) in different views 503, view an element's properties such as what side of an element is being worked on 504, delete or create an exact clone of the element 505 or to change or edit the metadata that is stored in the element 506. Further functionality may include allowing a user to select new non-storing elements 507 (FIG. 6) or storing elements 508 (FIG. 7) to insert into the map. Lastly, the user may be provided with functionality to save any updates, additions or changes 509. When the save button is pressed, the API starts using the newly saved information and the changes recorded in the historical database. As will be understood, the layout of the functionality buttons may be different than shown and that FIG. 5 only provides one schematic example of a layout of a map editor.

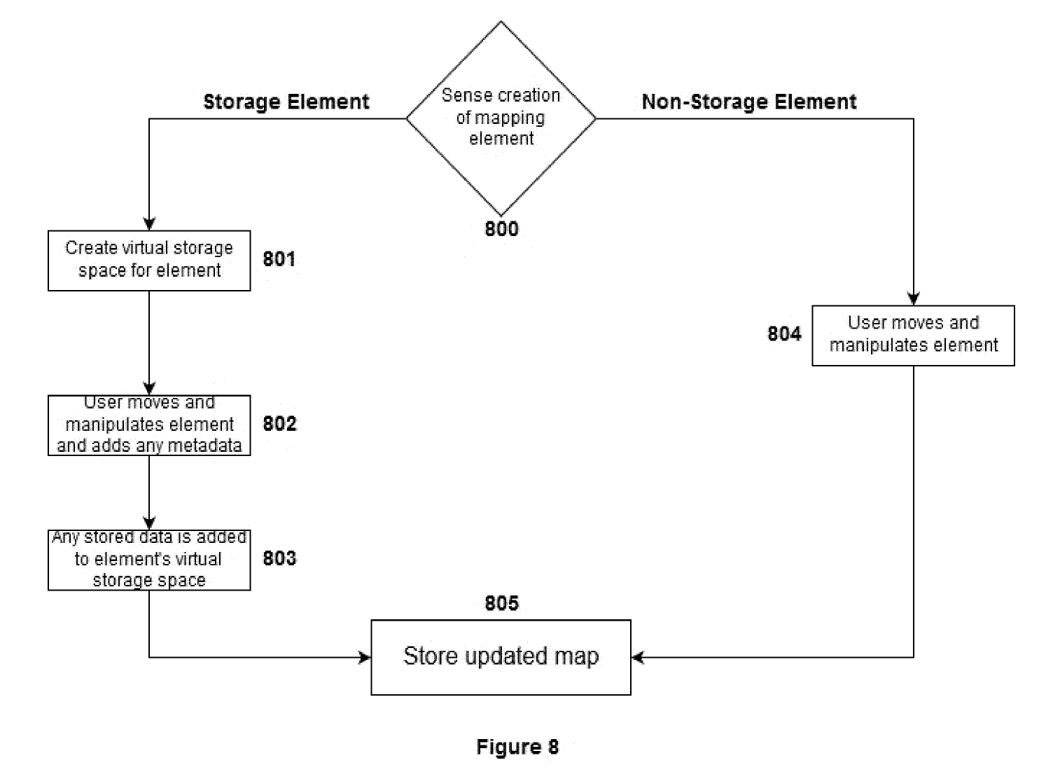

Turning to FIG. 8, a flowchart outlining a method of generating an element for a map is shown. Initially, the user selects the type of element that they would like to create such that the created element can be added to the map. This is sensed by the system 800. If it is sensed that a storing element is selected (path 810), the system creates, in the local database, a temporary virtual space for any stored metadata 801 associated with the new storing element. The system then senses the user's desired location for the element within the map and moves and adjusts the element or aspects of the element to reflect the request by the user 802. This may include any metadata associated with the storing element. If the user adds or changes any stored metadata inside the element to reflect any aspects the object would have at the physical location, this is sensed by the system and stored 803 so that the API can highlight it to guide consumers to that location within the store when the map is generated based on a request that includes this storing element. If the element selected is a non-storing element (path 812), the system senses and stores the placement of the element within the map by the user 804. When the user has finished doing this for this or all elements that need to be created or adapted to properly reflect the physical location, the map can be saved by the system 805. As such, any associated temporary storage may be turned permanent.

In accordance with the system of the disclosure, the map or maps being displayed (and the elements within the maps) may be different depending on the requesting source or how a user wants to edit the map. Typically, the different views fall into, but are not limited to, three types:

Store or Owner View—This view reflects how the location owner's systems and employees view or manage the map of the location. There could be storage areas that are not available to consumers or shoppers that need to be there for management purposes and thus are hidden from a customer's map view. Elements such as shelves could also have many more zones depicting more detail as to how the location is represented in internal systems.

Customer or Visitor View—This view is one that takes the complexity of the store or owner view and strips away anything that a customer should not see. The elements or aspects of elements that are shown are selected to guide the customer to the desired destination. The exactness of the destination can be altered to allow retailer or property owner to choose the complexity of the map that the customer can see so that they may see more of the location and thus spend more at the location.

Layout View—This view takes the customer or visitor view and allows summary terms to be placed in storing elements. What is contained in that area of the map can be summarized so that visitors can guide themselves to a desired area without having to request an exact destination or product. This can also help with using grouped area elements as a very complex location can be broken into sections or departments. When a section is selected, a more detailed layout map can be shown.

As outlined above, the system is not limited to these specific views as more views can be added for information such as safety information or to hide location data that could be considered sensitive.

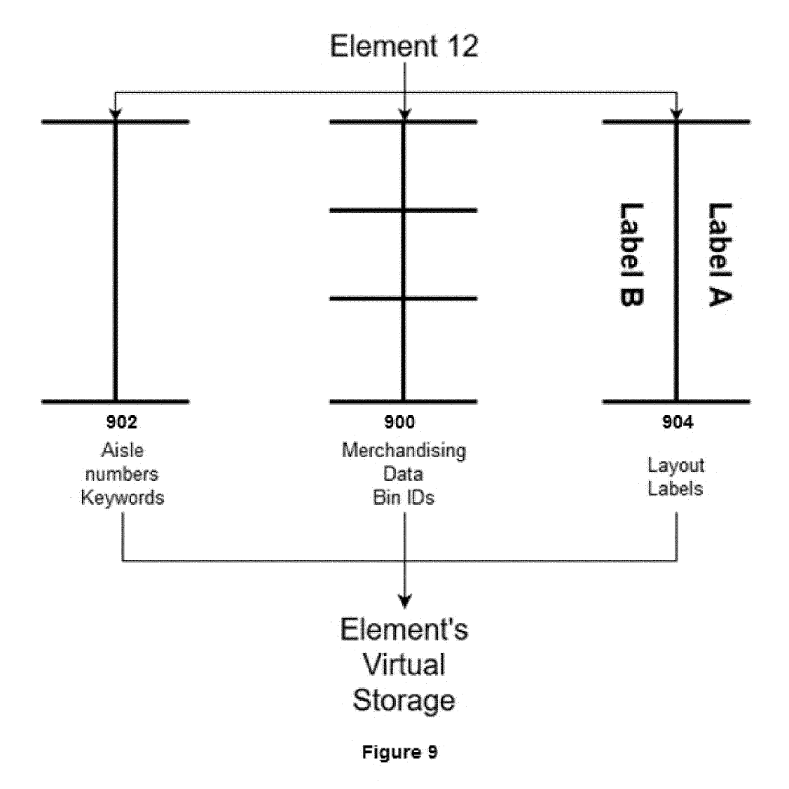

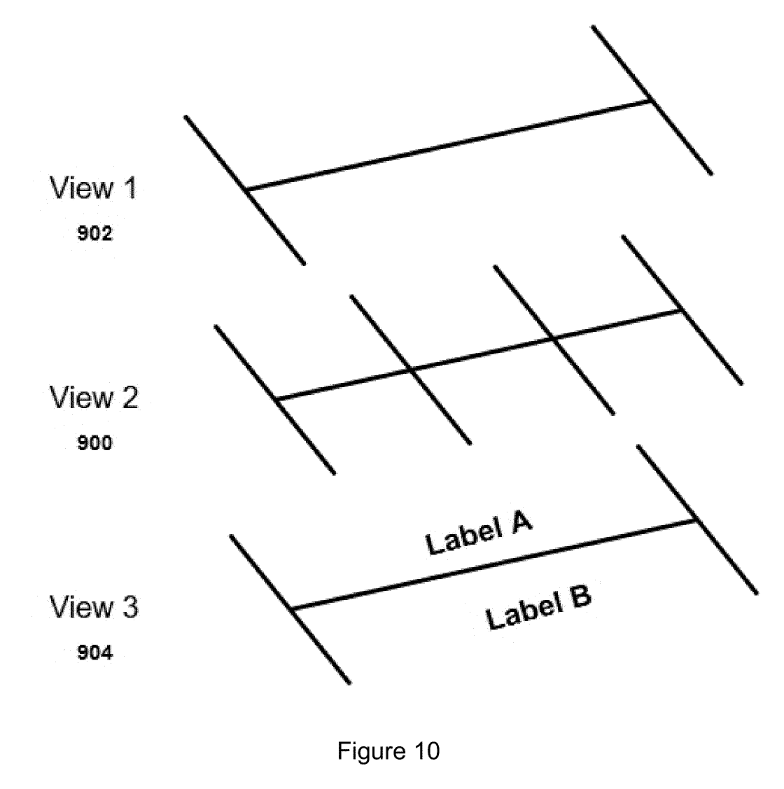

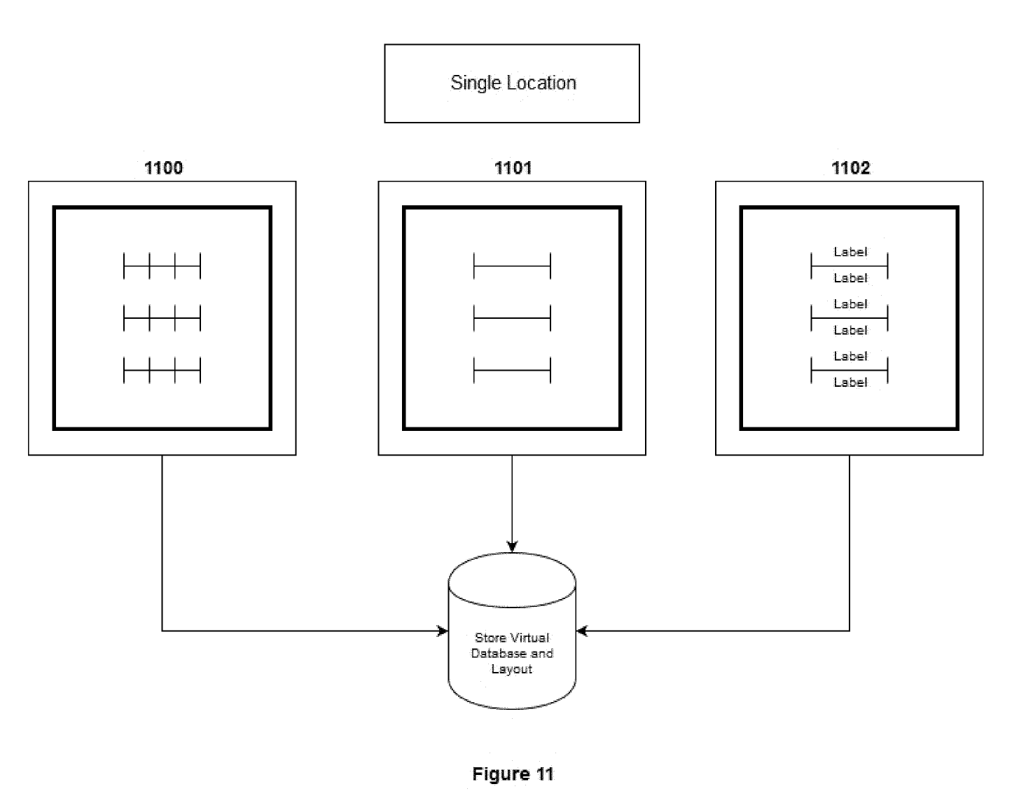

Turning to FIG. 9, as outlined above, storing elements may include metadata such that further information may be provided via these map elements to individuals looking at the map. A storing element has the capability to hold data for each different view (such as the ones discussed above) as shown in FIG. 9. The storing element is preferably the same in all views, just displaying different information. For example, the shelf of FIG. 9 may hold merchandising data in a store view 900, aisle numbers in a customer view 902 and colour coded layout labels in the layout view 904. Each of these forms a layer of the map as schematically depicted in FIG. 10 to be transmitted to different requesting sources. View 1 relates to the customer view 902, view 2 relates to the store view 900 and view 3 relates to the layout view 904. Elements can be individually viewed in different views in the map editor but when a map is requested, the generated map will show all the elements in the specified or requested view. The metadata pertaining to each view is saved independently in each element's virtual storage database 106, but the elements and all the culminating view data are preferably stored in the same location database as depicted in FIG. 11.

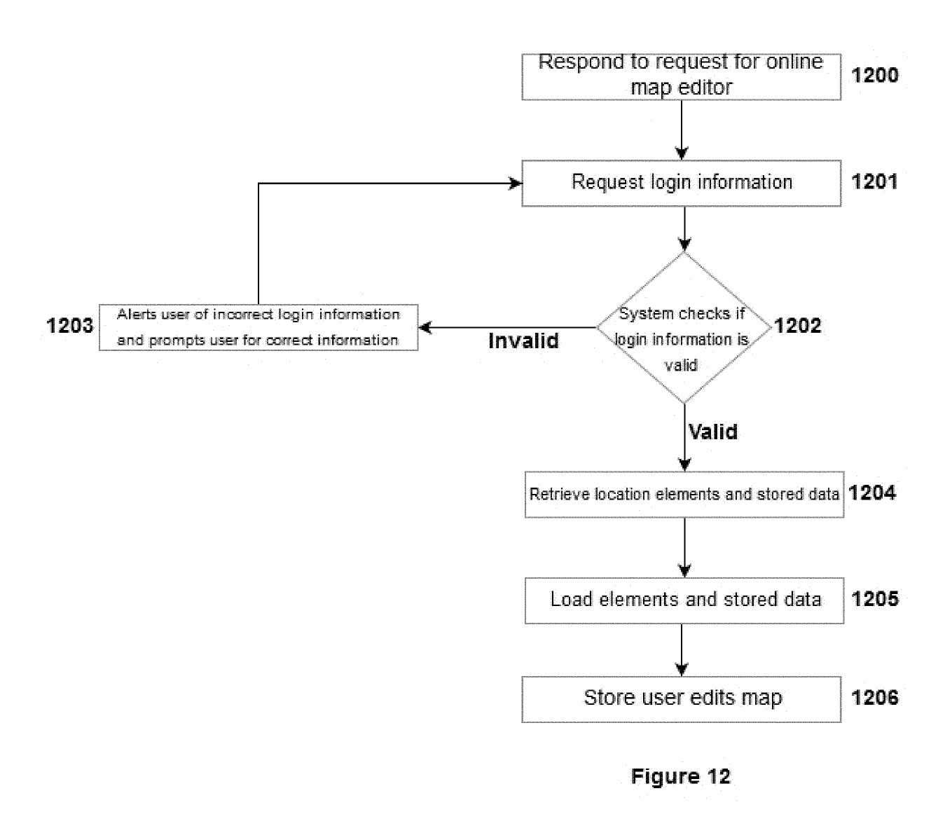

Turning to FIG. 12, a flowchart outlining a method of updating a map is shown. Initially, the system senses that a user has loaded, or requested, the map editor (1200). The system then requests login information from the user (1201). In one embodiment, the user may select a brand along with login information that is received by the system. The system then checks if the login information provided is valid 1202 and if it is not, the system returns a message to the user that their login information is incorrect (1203) and provides the user another opportunity to submit the login information (1201). If the user's information is authenticated, the system then sends a request to the central database for all the information stored in that location's virtual database 1204. In one embodiment, the API may retrieve URL information from the central database associated with the database 106 being requested and then retrieves the current map and map information from the database 106. The system, such as via the map editor, then loads all the information for the user 1205. Any changes and edits to the map are saved 1206 and the database updated such that when the map is subsequently requested by another requesting source, the requesting source receives a copy of the updated map.

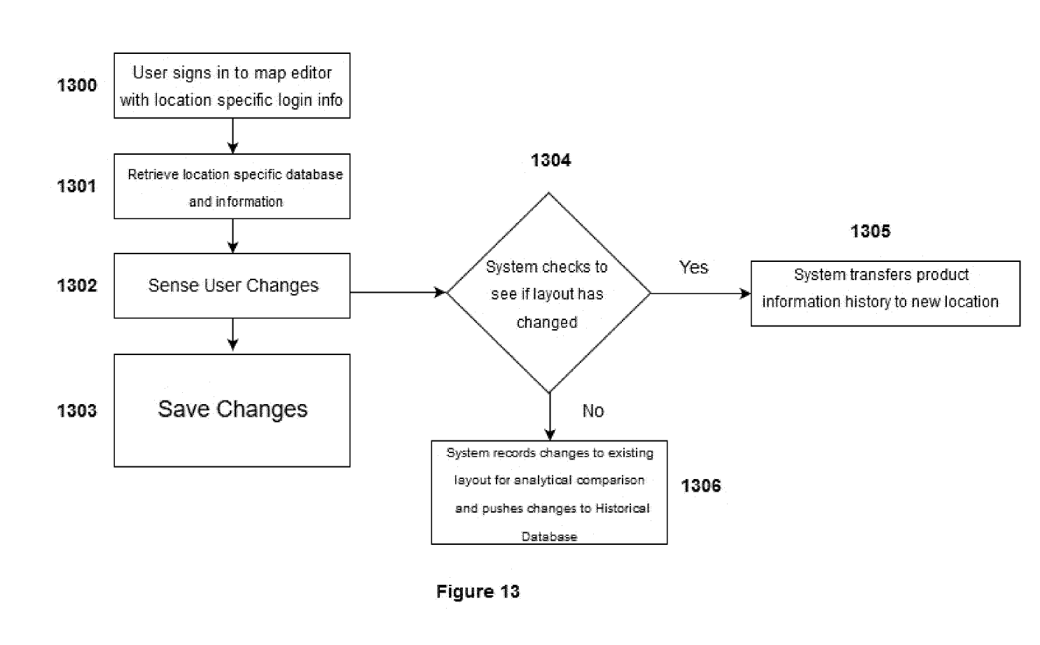

Turning to FIG. 13, a flowchart outlining another method of editing a map is shown. When there is a change at the physical location, the map is adjusted to reflect this change. A change to the location may include a change in layout or physical location.

Initially, a user logs in to the system (such as discussed above with respect to FIG. 12). Once the user has been authenticated (1301), the system requests all the data stored in that location's database (1302). This may be performed by either the API or the central database module. The user then makes the necessary changes in the map editor to reflect the changes to the physical location (which are sensed by the system) 1303 and then saves the changes 1304. At this point, the system uses the newly saved data for all map requests.

The system will also check if the layout of the elements has changed or whether data was moved 1305 and if so, the system makes note or stores this change in the historical database so that the changes can be reflected in future analytical maps 1306 and if there are no changes to the element locations, the system allows the seamless transfer of the data 1307.

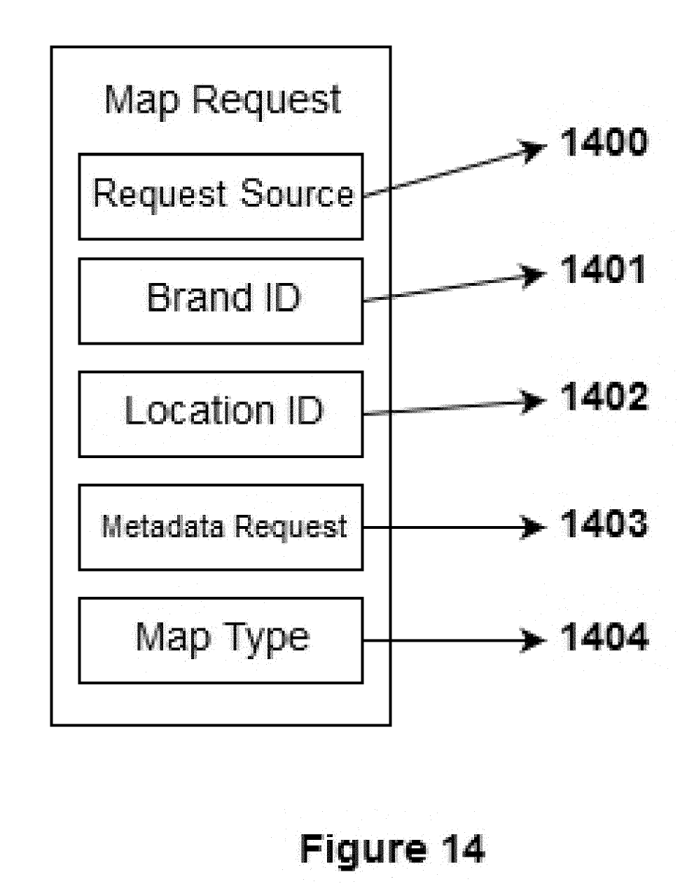

Turning to FIG. 14, a schematic diagram of a map request (such as one received by the system (or API)) from a requesting source is shown. In the current embodiment, a map request includes the requesting source 1400 (such as an application or website), the brand or network ID 1401 (which is the brand or company network that the location is in), the location ID for the account in that network 1402 (such as an internal location or store number), the metadata being requested such as the aisle that needs to be shown 1403 as well as the type of map being requested in the appropriate view 1404 (such as the customer view).

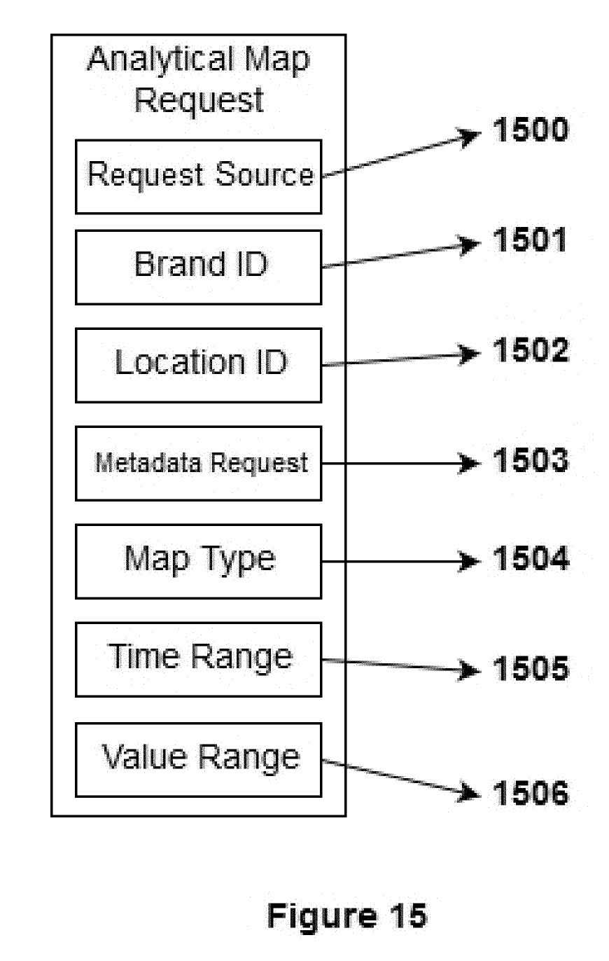

Turning to FIG. 15, a schematic diagram of an analytical map request is shown. In the current embodiment, an analytical map request includes a request source 1500, brand ID 1501, location ID 1502, the metadata being requested 1503 as well as the map type 1504. The analytical map request further includes a time range for the values in the analytical map 1505 as well as the value range 1506 which could allow, for example, any product over a certain dollar value to be removed from the map. The range characteristics may be used to generate the analytical map from either imported or historical data.

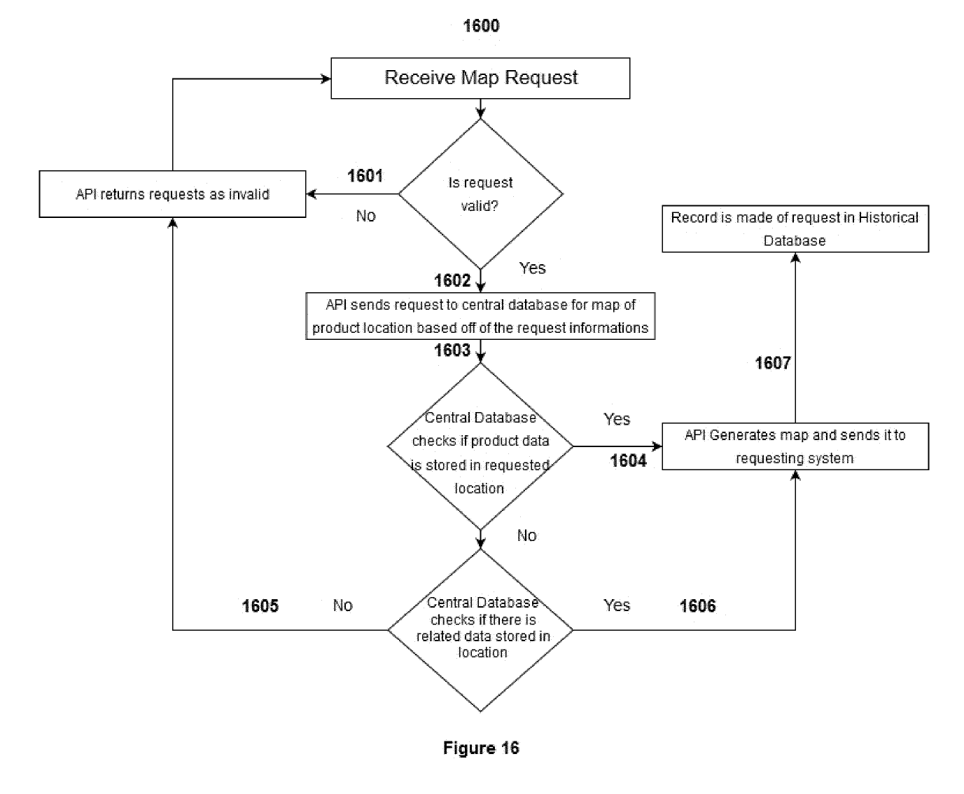

Turning to FIG. 16, a flowchart outlining a method of receiving a map request, such as from one of the requesting sources, is shown. First, a map request is received by the API from a property owner's internal system or a connected third party interface 1600. The API then checks if the request is valid and, if not, returns the request to the requesting source as invalid 1601 and then waits to receive an updated map request 1600.

If the request is deemed or determined to be valid, the API then requests the needed elements and data from the central database 1602. The central database then checks if the requested metadata is stored in the location that is being requested 1603. If the data is present, the API then generates the map and sends it to the requesting source 1604.

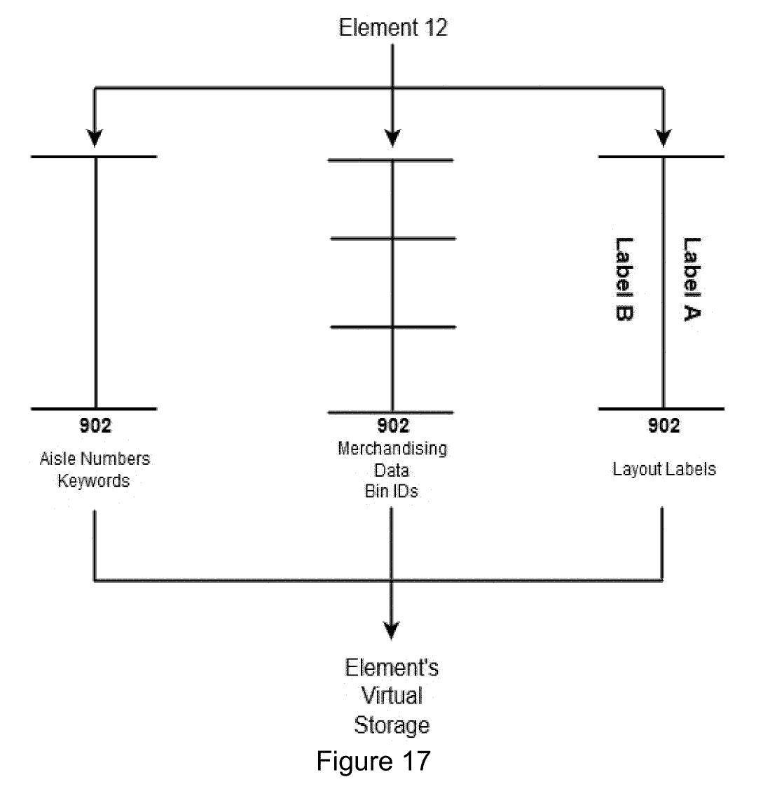

If the metadata being requested is not stored in the location's database, the central database then checks if there is any associated metadata that could be used as a substitute for the requested metadata. If the requested metadata is not in the central database and there is no valid alternative metadata, then the system returns the initial request to the sources as invalid 1605. If there is a suitable alternative, the API generates the map with the alternative metadata and sends it to the requesting source 1606. The system then records the request and details of the request in the historical database to be used in analytics later 1607. A visitor or customer map is then generated, such as seen in FIG. 17, where either the one or multiple zones that are requested are highlighted.

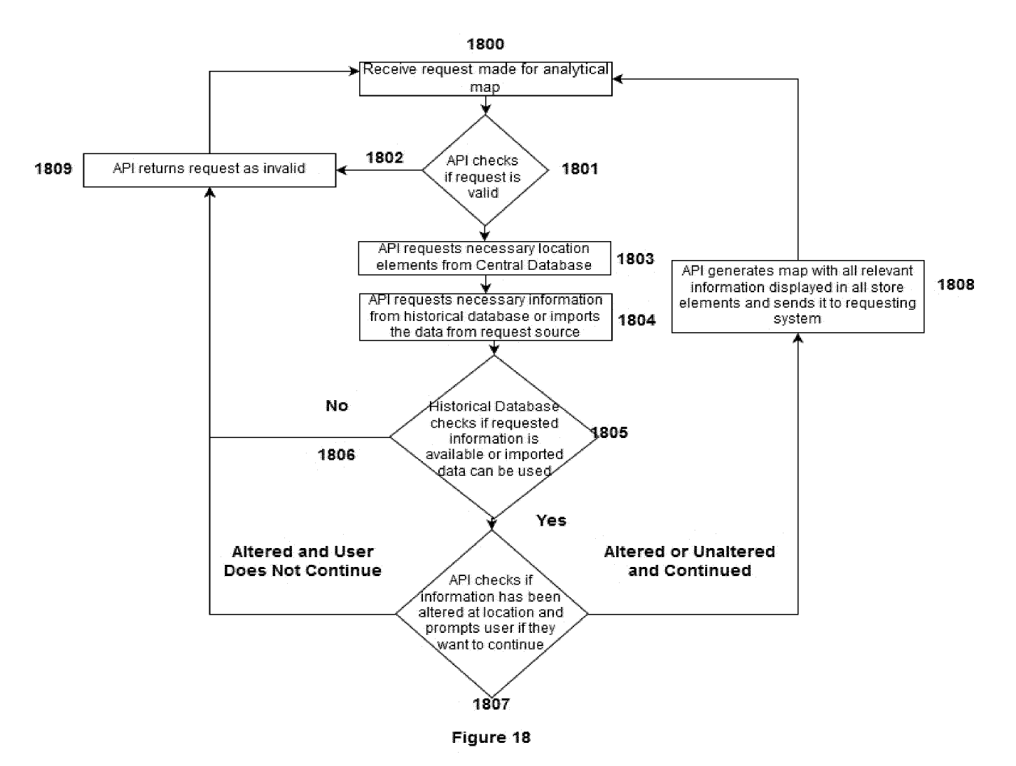

Turning to FIG. 18, a flowchart outlining a method of receiving an analytical map request is shown. For an internal or third party system to request an analytical map, there is a similar process as to a visitor or customer map. As before, the first step is for a property owner's internal system or any other approved third-party's system to transmit a request for an analytical map that is received by the system 1800. The API then checks to see if the request is valid 1801 and if not, returns the request as invalid 1802 and then waits for a further analytical map request 1800.

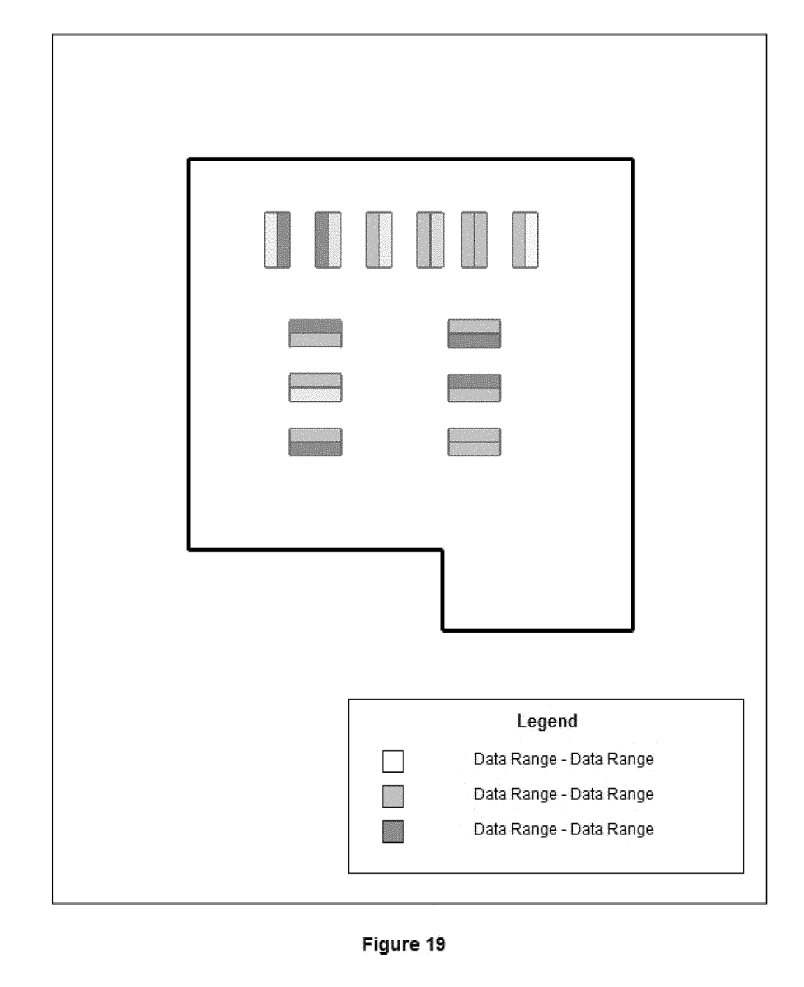

If the request is valid, the API then requests the necessary elements and their locations from the central database 1803. The API then requests the necessary values or data from the historical database or imports the necessary data from the request source and associates the imported data with the stored metadata 1804. The historical database then checks if the requested information is stored or if the imported data is associated to stored data within the database 1805. If the requested data is not available or the imported data can not be used, then the system returns the map request as invalid to the requesting source 1806. If the requested data is available or the imported data can be used, then the historical database checks to see if the layout of the location has changed during a requested time interval 1807. If there have been changes and the user does not wish to continue, then the system returns the request as invalid to source. If there have been no changes to the layout of the location or there have been changes and the user wishes to continue, the API then generates the analytical map and returns it to the requesting source 1808. The generation of an analytical map may result in a map as schematically shown in FIG. 19 where all appropriate zones are highlighted to visually represent the value and time ranges requested. The legend represents the scale of the data being analyzed. For example, one colour may represent $4,000+ in sales while another may represent $2,000-$4,000 in sales to provide context for what is being analyzed.

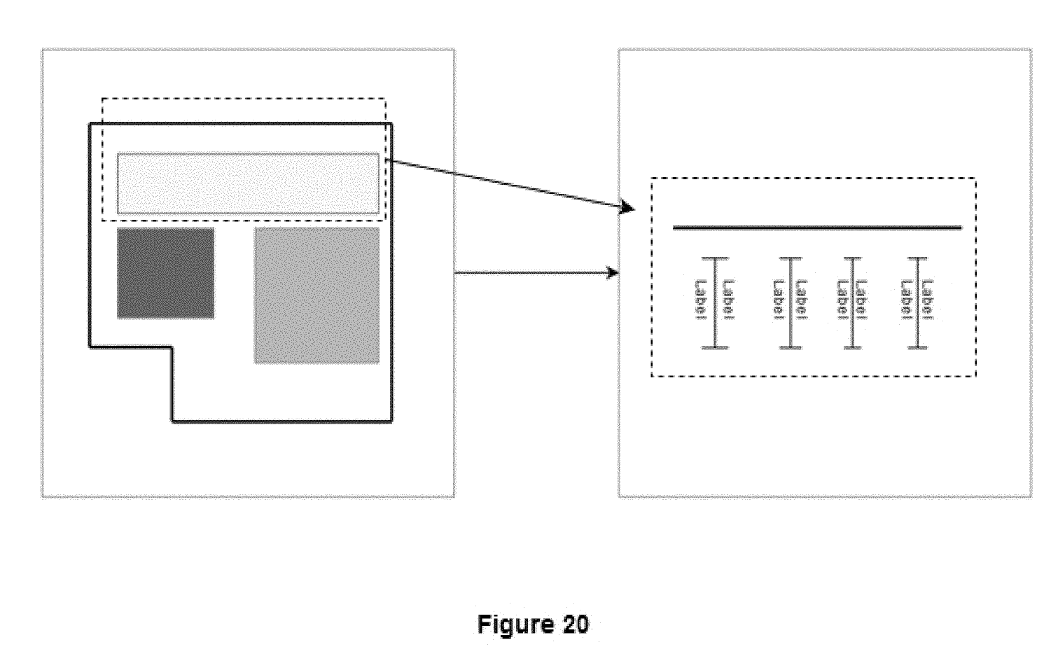

Another advantage of the current disclosure is the generation of a customer or consumer map that where areas of the map can be grouped together. This can be schematically seen with respect to FIG. 20 where when an area of a map is selected, the system shows a more detailed map of that area. This can also be used to create a two-step map where both the area that a customer has selected is highlighted as well as where that area is in context of a much larger area.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

What is claimed is:

1. A system for in-store digital mapping comprising:
an application programming interface (API) for receiving a mapping request from a requesting source;
a first database for storing data relating to maps associated with physical locations; and
a second database for storing historical data relating to maps associated with physical locations.

2. The system of claim 1 wherein the API comprises:
a central database module;
a historical database module;
a property owner's systems module; and
a third-party systems module.

3. The system of claim 2 wherein the third-party's system's module communicates with requesting sources outside a retailer's network.

4. The system of claim 2 wherein the property owner's systems module communicates with requesting sources within a retailer's network.

5. The system of claim 2 wherein the central database module communicates with the first database.

6. The system of claim 2 wherein the historical database module communicates with the second database.

7. The system of claim 1 further comprising a map editor connected to the first database.

8. The system of claim 7 wherein the map editor is web-based.

9. A method of generating an in-store map comprising:
determining if a user has selected a storing element or a non-storing element;
retrieving metadata associated with the storing element if a user has selected a storing element, sensing placement of selected storing or non-storing element in map; and
storing placement of selected or non-storing element and metadata in a central database.

10. The method of claim 9 further comprising:
determining if a map has been updated; and
storing changes or updates to the map in a historical database.

11. A method of digital map generation comprising:
receiving a request for a map from a requesting source;
determining a type of map requested;
accessing a database to retrieve the type of map requested;
generating the map based on the type of map requested; and
transmitting the generated map to the requesting source.

12. The method of claim 11 wherein determining the type of map requested comprises:
determining if a store location map or an analytical map is requested.

13. The method of claim 12 wherein if a store location map is requested, accessing the database to retrieve the type of map requested comprises:
retrieving the store location map from a central database.

14. The method of claim 12 wherein if an analytical map is requested, accessing the database to retrieve the type of map requested comprises:
retrieving the analytical map from a historical database.

15. The method of claim 13 further comprising:
determining a view of the store location map being requested.

16. The method of claim 15 wherein transmitting the generated map to the requesting source comprises:
transmitting a map based on the determined view.
